(19) United States
(12) Patent Application Publication
(10) Pub. No.: US 2009/0015961 A1
(43) Pub. Date: Jan. 15, 2009

(54) DISK DRIVE INSTALLED IN PORTABLE ELECTRONIC DEVICE, AND METHOD OF UNLOADING A HEAD WHEN THE ELECTRONIC DEVICE FALLS

(75) Inventor: Tatsuharu Kusumoto, Higashiyamato-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/141,338

(22) Filed: Jun. 18, 2008

(30) Foreign Application Priority Data
Jul. 12, 2007 (JP) 2007-183619

(51) Int. Cl. G11B 21/02

(52) U.S. Cl. 360/75

(57) ABSTRACT

According to one embodiment, a disk drive (HDD) is installed in a portable electronic device. The HDD includes an actuator which supports a head such that the head is radially movable over a disk. A constant speed controller incorporated in the HDD executes constant speed control for unloading the head onto a ramp at a constant speed in accordance with a fall detection signal output from a fall detector and indicating that fall of the device has been detected. In the constant speed control, the controller drives a voice coil motor as a drive source for the actuator to make the movement speed of the head identical to a first target speed. The first target speed is set higher than a second target speed set when the head is unloaded onto the ramp in a normal state.

### CROSS-REFERENCE TO RELATED APPLICATIONS

This application is based upon and claims the benefit of priority from Japanese Patent Application No. 2007-183619, filed Jul. 12, 2007, the entire contents of which are incorporated herein by reference.

### BACKGROUND

1. Field

One embodiment of the invention relates to a disk drive for writing/reading information using a head, and more particularly, to a disk drive installed in a portable electronic device and suitable for unloading a head when the electronic device falls.

2. Description of the Related Art

In these years, in accordance with downsizing of disk drives, various types of portable electronic devices provided with the downsized disk drives have been come to be available. Portable personal computers, video cameras, music players, portable terminals, mobile phones are known as such portable electronic devices.

However, it is possible that portable electronic devices will unintentionally fall when they are carried and used by users.

In light of this, Jpn. Pat. Appln. KOKAI Publication No. 2007-115309 discloses a technique (conventional head unloading technique) of quickly unloading a head to a lamp (head retract area) when an electronic device with a disk drive mounted thereon falls. In the conventional head unloading technique, the speed (movement rate) of the head is controlled based on servo data periodically read from a magnetic disk by the head, until the head reaches the outer periphery of the magnetic disk. More specifically, the position of the head is detected based on the servo data read by the head, and the speed of the head is controlled based on the detected head position.

However, after the head reaches the outer periphery of the magnetic disk, reading of servo data cannot be achieved, and hence the head position cannot be detected. Therefore, in the conventional head unloading technique, after the head reaches the outer periphery of the magnetic disk, control of unloading the head to the lamp at a constant speed is realized by monitoring the back electromotive force (back EMF) of a voice coil motor (VCM).

Further, in the conventional head unloading technique, when, for example, the electronic device falls with the head positioned in a radially inner position on the magnetic disk, the head speed can be set higher, until the head reaches the outer periphery of the magnetic disk, than the constant speed at which the head is unloaded in a normal state. To this end, it is necessary for the head to correctly read the servo data recorded on the disk, until the head reaches the outer periphery of the disk.

However, where the electronic device is falling, it is strongly possible that variation (so-called jitter) occurs in the rotational speed of the disk. If the rotational speed of the disk varies, it is difficult for the head to correctly read the servo data (in particular, cylinder address data included in the servo data) recorded on (embedded in) the disk at regular circumferential intervals. If the head speed is controlled based on the servo data erroneously read by the head, a dumping phenomenon, in which the head speed significantly varies, may well occur. In this case, it is difficult to unload the head onto the lamp stably and reliably.

### BRIEF DESCRIPTION OF THE SEVERAL VIEWS OF THE DRAWINGS

A general architecture that implements various features of the invention will now be described with reference to the drawings. The drawings and their associated descriptions are provided to illustrate the embodiments of the invention and not to limit the scope of the invention.

FIG. 1 is a block diagram illustrating an exemplary configuration of an electronic device (disk drive) according to an embodiment of the invention;

FIG. 2 is a block diagram illustrating an exemplary configuration of an emergency unload controller incorporated in a disk drive shown in FIG. 1;

FIG. 3 is a flowchart illustrating an exemplary procedure for the entire electronic device performed when fall of the disk drive is detected;

FIG. 4 is a flowchart illustrating an exemplary procedure of emergency unload control performed in the disk drive;

FIG. 5 is a flowchart illustrating an exemplary procedure of constant speed control included in the emergency unload control of FIG. 4;

FIG. 6 is a view illustrating an exemplary relationship between the speed and accelerated speed of a head and the elapsed time during constant speed control, assumed in each position of the head on a disk at the start of the control; and

FIG. 7 is a block diagram illustrating an exemplary configuration of the essential part of a disk drive according to a modification of the embodiment.

### DETAILED DESCRIPTION

Various inventions according to the invention will be described hereinafter with reference to the accompanying drawings. In general, according to one embodiment of the invention, a disk drive installed in a portable electronic device is provided. The portable electronic device includes a fall detector for detecting fall of the portable electronic device. The disk drive comprises: a head used to write and read data to and from a disk; a ramp onto which the head is unloaded; an actuator which supports the head such that the head is radially movable over the disk, the actuator including a voice coil motor as a driving source for the actuator; and a constant speed controller configured to unload the head onto the ramp at a constant speed in accordance with a fall detection signal output from the fall detector and indicating that fall of the portable electronic device has been detected. The constant speed controller executes constant speed control for driving the voice coil motor to make a movement speed of the head identical to a first target speed, the first target speed being set higher than a second target speed set when the head is unloaded onto the ramp in a normal state.

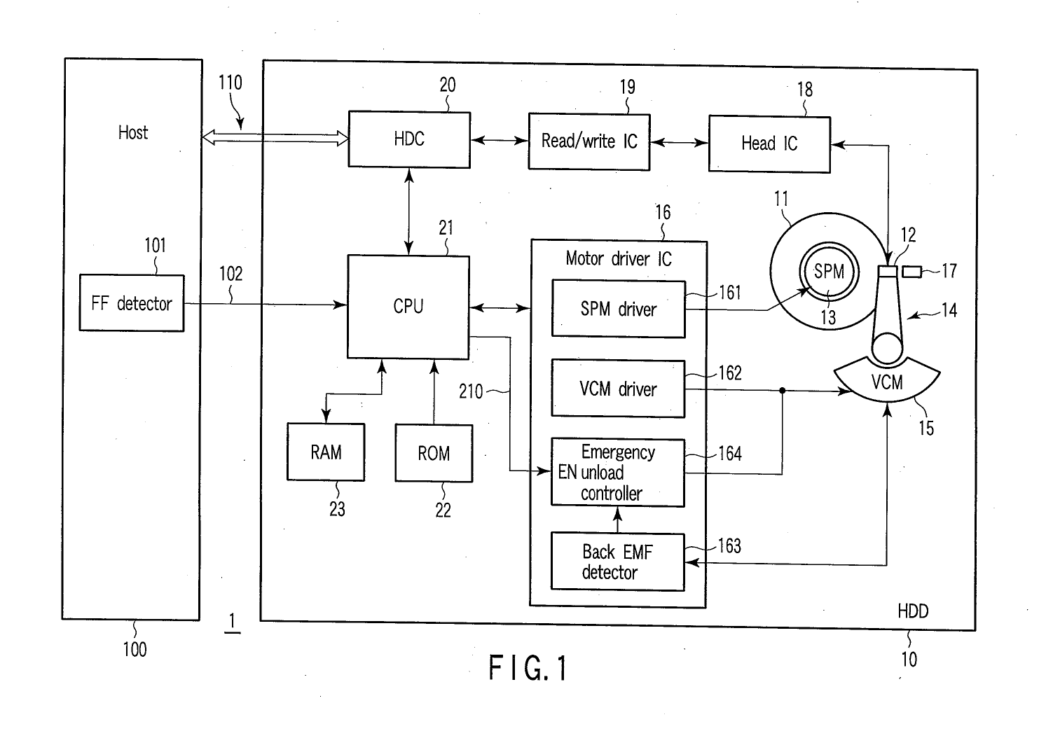

FIG. 1 is a block diagram illustrating an exemplary configuration of an electronic device 1 according to an embodiment of the invention. The electronic device 1 is a portable electronic device such as a portable personal computer, video camera, music player, mobile terminal and cellular phone.

The electronic device 1 is loaded with a hard disk drive (HDD) 10. The electronic device 1 includes a host 100 that uses the HDD 10 as a storage unit. The HDD 10 and host 100 are contained in the housing of the electronic device 1. In general, the housing of an electronic device also serves as that of a host. The HDD 10 is connected to the host 100 via a host interface 110.

The host 100 contains a free fall (FF) detector 101. The FF detector 101 detects fall (e.g., free fall) of the electronic device 1. The FF detector 101 is a known triaxial acceleration sensor. Upon detecting fall of the electronic device 1, the FF detector 110 informs the HDD 10 of this, using a fall detection signal 102. The FF detector 101 may be incorporated in the HDD 10.

The HDD 10 includes a disk (magnetic disk) 11 as a recording medium. The disk 11 has two, i.e., upper and lower, surfaces. The upper surface, for example, of the disk 11 serves as a recording surface for magnetically recording data thereon. A head (magnetic head) 12 is provided opposing the recording surface of the disk 11. The head 12 is used to read and write data from and to the disk 11. For facilitating drawing, FIG. 1 shows an example of the HDD 10 that incorporates only one head 12. In general, however, both sides of the disk 11 serve as recording surfaces, and heads are provided corresponding to the respective disk surfaces. Further, in the configuration of FIG. 1, an HDD 10 having a single disk 11 is considered. However, the HDD 10 may incorporate a plurality of disks 11 stacked on one another.

The disk 11 is spun at high speed by a spindle motor (SPM) 13. The head 12 is attached to the tip of an actuator 14. The actuator 14 has a voice coil motor (VCM) 15 as a source for driving the actuator 14. The actuator 14 is driven by the VCM 15 to radially move the head 12 on the disk 11. Namely, the actuator 14 supports the head 12 so that the head 12 can radially move over the disk 11. By the operation of the actuator 14, the head 12 is positioned on a target track of the disk 11. The SPM 13 and VCM 15 are powered by respective driving currents supplied from a motor driver IC 16. The motor driver IC 16 will be described in detail later.

The disk 11 has an inner periphery and outer periphery. A ramp 17 is provided away from the recording surface of the disk 11, for example, near the outer periphery of the disk 11. The ramp 17 serves as a retract area (parking area) for retracting the head 12 when the HDD 10 is in an inoperative state. Assume here that the inoperative state includes a particular power-saving mode state, as well as a state in which the HDD 10 is completely stopped.

The head 12 is connected to a head IC (head amplifier circuit) 18 via a wiring pattern formed on a flexible printed cable (FPC), not shown. The head IC 18 includes a read amplifier (not shown) for amplifying a signal (read signal) read by the head 12, and a write driver (not shown) for converting write data into write current.

The head IC 18 is connected to a read/write IC (read/write channel) 19. The read/write IC 19 is a signal processing circuit for performing various types of signal processing, such as analog-to-digital (A/D) conversion performed on a read signal amplified by the head IC 18, servo detection for extracting servo data from A/D converted data, decoding of A/D converted data (read data), and encoding of write data.

The read/write IC 19 is connected to a disk controller (HDC) 20. The HDC 20 is connected to a CPU 21. The HDC 20 is also connected to the host 100 via the host interface 110. The HDC 20 has a disk interface control function of receiving a command (write command, read command, etc.) from the host 100 via the host interface 110, and controlling data transfer between the host 100 and HDC 20 itself. The HDC 20 also has a disk interface control function of controlling data transfer between the disk 11 and HDC 20 itself performed via the read/write IC 19. Further, the HDC 20 serves as an interface for the CPU 21.

The CPU 21 is connected to the motor driver IC 16, and to a ROM 22 and RAM 23. The ROM 22 pre-stores a control program (firmware) to be executed by the CPU 21. The RAM 23 serves as the working area of the CPU 21. When the CPU 21 executes the control program, it serves as the main controller of the HDD 10. When the CPU 21 is informed of fall of the electronic device 1 by the fall detection signal 102 emitted from the FF detector 101 of the host 100, it sets the HDD 10 in an emergency unload mode designed to be set during fall. To this end, the CPU 21 outputs an emergency unload signal 210 indicating the emergency unload mode.

The motor driver IC 16 comprises an SPM driver 161, VCM driver 162, back electromotive force detector (back EMF detector) 163, and emergency unload controller 164. The SPM driver 161 supplies the SPM 13 with a driving current (SPM current) of the amount designated by the CPU 21.

The VCM driver 162 supplies the VCM 15 with a driving current (VCM current) of the amount designated by the CPU 21. The VCM driver 162 is used for seek control, head positioning control (track following control), head load control and normal head unload control performed by the CPU 21. Seek control is performed to move the head 12 to a target track on the disk 11. Head positioning control is performed to settle, in a target area on the target track, the head 12 currently positioned on the target track. Head load control is performed to move, to the disk 11, the head retracted on the ramp 17. Normal head unload control is performed to normally retract, to the ramp 17, the head 12 positioned on the disk 11. The VCM driver 162 is disabled at last in an emergency unload mode.

For normal head unload control, constant speed control is employed to move the head 12 at a preset heat movement speed (target speed) TVn. When the head 12 is retracted to the ramp 17 at a certain seed (TVn in the case of normal unload control), it may jump out of the ramp 17. To avoid this, the HDD 10 also incorporates a stopper (not shown) to be engaged with the actuator 14. The stopper generally has a latch function. When the head 12 is retracted to the ramp 17, the actuator 14 is latched by the stopper. As a result, the actuator 14 is prevented from being hit by the stopper back to the disk 11.

The back EMF detector 163 detects back electromotive force that occurs in the VCM 15 when the VCM 15 is driven. As is well known, the back electromotive force of the VCM 15 corresponds to the movement speed (head movement sped) of the head 12 moved by powering the VCM 15. More specifically, the back electromotive force of the VCM 16 reflects the movement speed of the head 12, and is proportional to the same.

The emergency unload controller 164 has an enable terminal EN for receiving an emergency unload signal 210 from the CPU 21. In the operable state, the emergency unload controller 164 performs emergency head unload control for urgently moving the head 12 to the ramp 17. To perform emergency head unload control, the emergency unload controller 164 supplies VCM current to the VCM 15 to power the same.

During emergency head unload control, constant speed control is performed in which the head 12 is moved to the ramp 17 at a target speed (second target speed) TVe higher than the target speed TVn (first target speed) employed during normal head unload control. For constant speed control, the emergency unload controller 164 periodically samples (i.e., samples in constant sampling cycles) back electromotive force values detected by the back EMF detector 163. The first target speed TVn is 10 cm/s, and the second target speed TVe is 60 cm/s.

The motor driver IC 16 includes an emergency unload control circuit (not shown) for urgently retracting the head 12 to the ramp 15 upon power off. The power supply voltage of an auxiliary power supply is used as the operation voltage of the emergency unload control circuit upon power off. The auxiliary power supply is, for example, a capacitor charged with the power supply voltage of the HDD 10 in the normal state. For emergency unload control performed upon power off, so-called open loop control is performed in which current caused by discharge of the capacitor is supplied to the VCM 15. When speed control is not performed (cannot be performed) to unload the head 12, the speed of movement of the head 12 to the ramp 17 becomes too high, resulting in an increase in the degree of damage to the head 12.

The back electromotive force that occurs in the SPM 13 during its rotation may be used as the auxiliary power. This back electromotive force is generated while the SPM 13 continues to rotate because of inertial force even after the supply of current (SPM current) to the SPM 13 is interrupted. Therefore, the back electromotive force of the SPM 13 can be used as auxiliary power during power off.

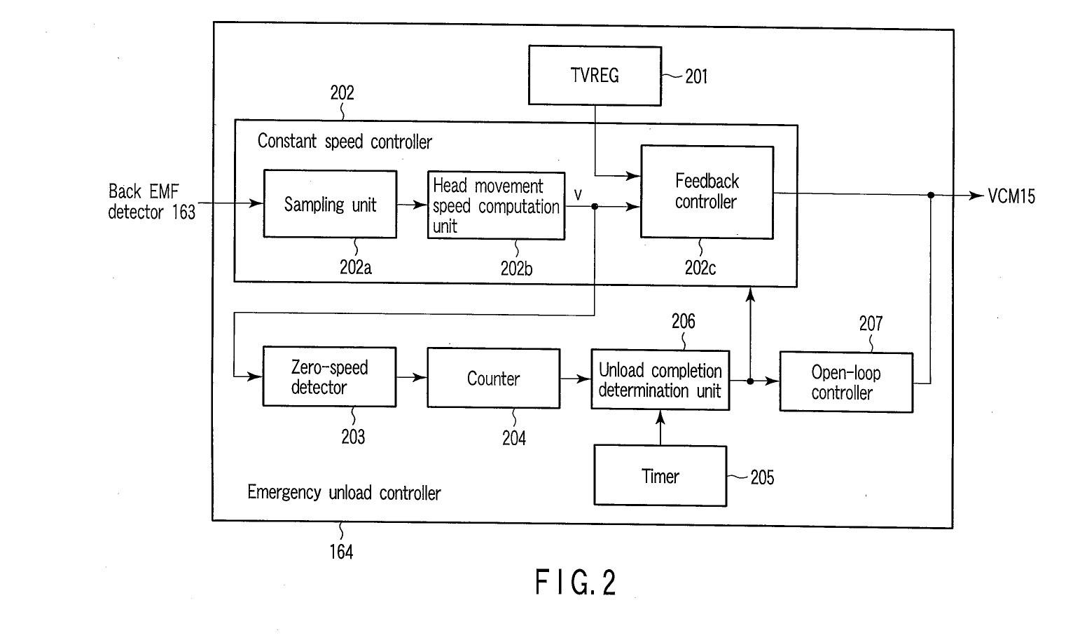

FIG. 2 is a block diagram illustrating the configuration of the emergency unload controller 164. The emergency unload controller 164 comprises a target speed register (TVREG) 201, constant speed controller 202, zero-speed detector 203, counter 204, timer 205, unload completion determination unit 206 and open-loop controller 207.

The target speed register 201 is used to set information indicating the target speed TVe. The constant speed controller 202 performs constant speed control for moving the head 12 to the ramp 17 at the target speed TVe indicated by the target speed register 201. The zero-speed detector 203 detects, in the aforementioned constant sampling cycles, whether the movement speed (head movement speed) v of the head 12 is zero (cm/s). The counter 204 counts the number of times (number of times of sampling) the zero-speed detector 203 successively detects that the head movement speed v of the head 12 is zero (cm/s).

The timer 205 measures a preset time Tc elapsing from the start of emergency unload control. The preset time Tc is set sufficient to reliably unload (retract) the head 12 from a radially inner position on the disk 11 onto the ramp 17 at the target speed TVe, and is shorter than a time Td required for the electronic device 1 to fall by a preset distance Ld. In other words, the target speed TVe is set to a value required to unload the head 12 from a radially inner position on the disk 11 onto the ramp 17 within the time Tc. The distance Ld is the distance between a fall-start position and a landing position, such as a floor or ground, estimated when a user unintentionally falls the electronic device 1.

The unload completion determination unit 206 determines that emergency head unloading, based on constant speed control by the constant speed controller 202, has been completed (normally completed) when the count value CNT of the counter 204 exceeds a preset reference number Nr. The unload completion determination unit 206 determines that abnormal emergency head unloading is performed, when the timer 205 measures the time Tc before the count value CNT exceeds the preset reference number Nr. The open-loop controller 207 unloads the head 12 to the ramp 17 by open loop control when the unload completion determination unit 206 detects abnormal emergency head unloading.

The constant speed controller 202 comprises a sampling unit 202a, head movement speed computation unit 202b and feedback controller 202c. The sampling unit 202a samples, with preset sampling cycles, the back electromotive force of the VCM 15 detected by the back EMF detector 163. As described above, the back EMF of the VCM 15 corresponds to the movement speed of the head 12. Accordingly, sampling of the back EMF of the VCM 15 by the sampling unit 202a is equivalent to sampling of the movement speed (head movement speed) of the head 12.

The head movement speed computation unit 202b computes the movement speed (head movement speed) of the head 12 corresponding to the back EMF, based on sampled values of the back EMF. The feedback controller 202c performs feedback control for driving the VCM 15 so that the computed head movement speed v will be equal to the target speed TVe.

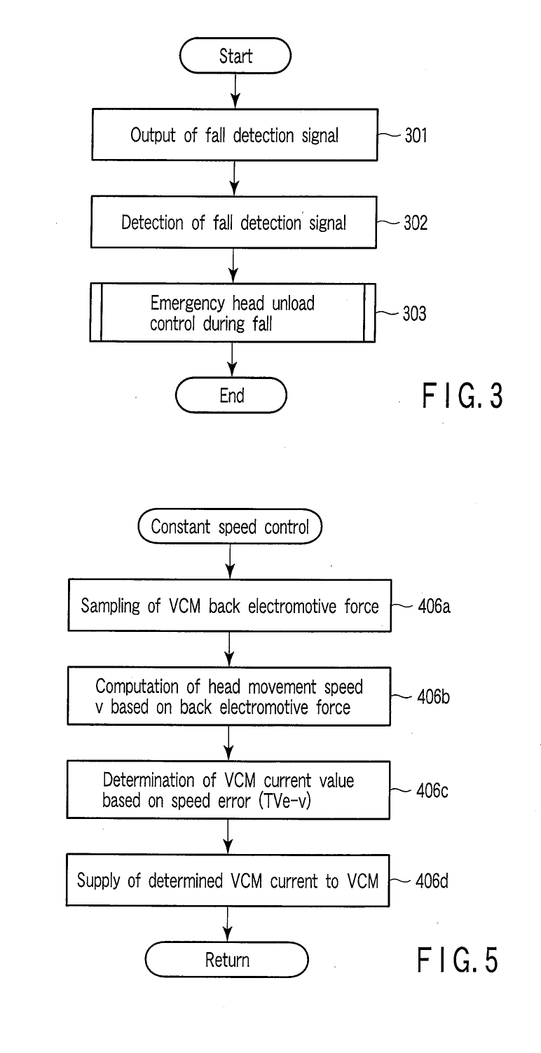

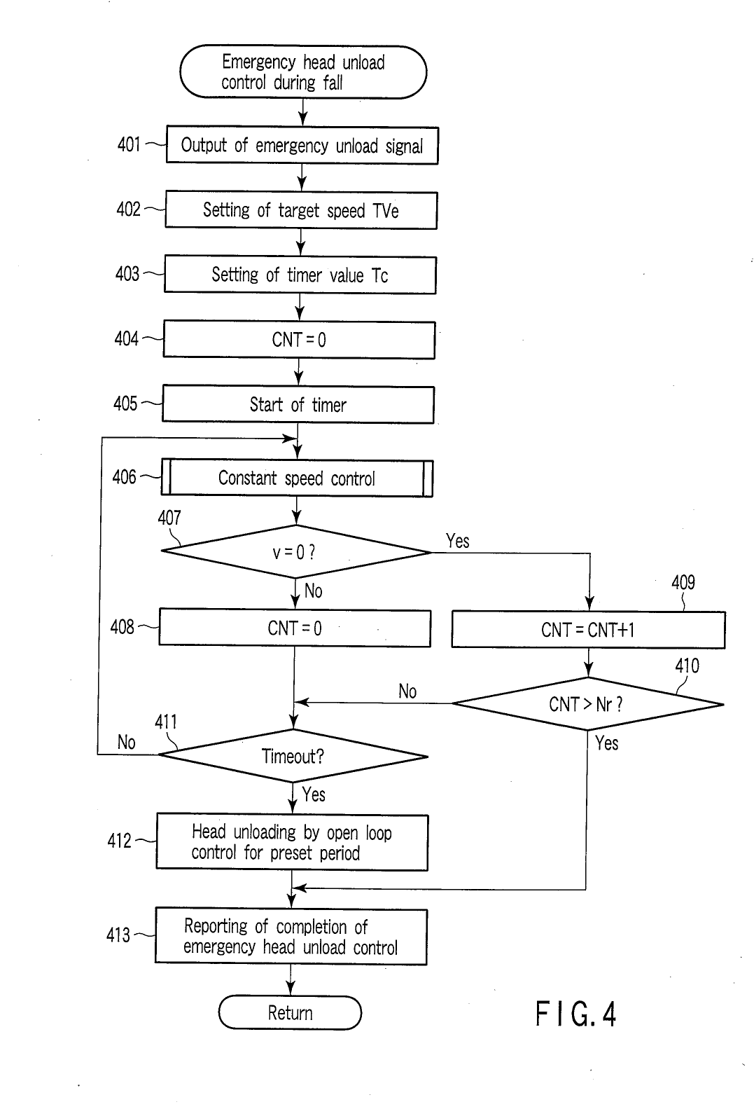

Referring then to the flowcharts of FIGS. 3 to 5, a description will be given of the operation of the embodiment performed, for example, when the FF detector 101 has detected fall of the electronic device 1. FIG. 3 is a flowchart illustrating a procedure for the entire electronic device 1 performed when fall of the device is detected. FIG. 4 is a flowchart illustrating an exemplary procedure of emergency unload control performed in the HDD 10. FIG. 5 is a flowchart illustrating an exemplary procedure of constant speed control performed by the constant speed controller 202.

Assume here that the electronic device 1 accidentally slips from the hand of a user. At this time, the electronic device 1 falls freely. The free fall of the electronic device 1 is detected by the FF detector 101 installed in the host 100 of the electronic device 1. While detecting the free fall of, for example, the electronic device 1, the FF detector 101 outputs an effective fall detection signal 102 (block 301). The fall detection signal 102 is transferred to the HDD 10 via, for example, a non-occupied signal line of the host interface 110.

The effective fall detection signal 102 from the FF detector 101 of the host 100 is input as, for example, an interruption signal to the CPU 21 of the HDD 10. Upon detecting the fall detection signal 102 as an interruption signal, the CPU 21 determines that the fall of the electronic device 1 is reported from the host 100 (block 302). At this time, the CPU 21 sets the HDD 10 in an emergency unload mode that is to be set during falling, and cooperates with the emergency unload controller 164 of the motor driver IC 16 to perform emergency head unload control that is to be performed during falling (block 303). At this time, the CPU 21 causes the HDC 20 to supply the host 100 with a busy signal indicating that the HDD 10 is in a busy state.

The emergency head unload control is performed as follows: Firstly, the CPU 21 outputs an effective emergency unload signal 210 indicating the emergency unload mode (block 401). The emergency unload signal 210 is input to the enable terminal EN of the emergency unload controller 164 of the motor driver IC 16. At this time, the emergency unload controller 164 is activated.

Subsequently, the CPU 21 sets, in the target speed register 201 of the emergency unload controller 164, information indicating the target speed TVe for emergency head unload control performed during falling (block 402). Further, the CPU 21 sets the initial value (initial timer value) Tc in the timer 205 of the emergency unload controller 164 (block 403).

At this time, the emergency unload controller 164 initializes (clears) the count value CNT of the counter 204 (block 404) to be zero, and activates the timer 205 (block 405). After that, the constant speed controller 202 of the emergency unload controller 164 performs constant speed control for unloading (moving) the head 12 to the ramp 17 at the target speed TVe (block 406), as follows:

The sampling unit 202a of the constant speed controller 202 samples the back electromotive force values of the VCM 15 detected by the back EMF detector 163 (block 406a). The head movement speed computation unit 202b multiplies each sampled back electromotive force value by a preset coefficient (proportional coefficient) to compute the movement speed (head movement speed) v of the head 12 at the point corresponding to each sampled value (block 406b). Namely, the head movement speed computation unit 202b converts each sampled back electromotive force value into the head movement speed v assumed when each back electromotive force value is sampled.

The feedback controller 202c determines the VCM current value necessary for the head 12 to reach the target speed TVe, based on the difference (speed error) “TVe-v” between the computed head movement speed v and the target speed TVe (block 406c). The feedback controller 202c supplies a VCM current of the determined value to the VCM 15 (block 406d). Namely, the feedback controller 202c performs feedback control based on the speed error “TVe-v” so that the movement speed of the head 12 will reach the target speed TVe. For this feedback control, a known Proportional-Integral-Derivative-algorithm (PID algorithm), for example, can be used.

In the above-mentioned constant speed control by the constant speed controller 202, each sampled back electromotive force value is converted into a head movement speed. However, if the target speed TVe is beforehand converted into the back electromotive force of the VCM 15, and the resultant back electromotive force is used as the target speed TVe for convenience, the sampled back electromotive force itself can be used as the head movement speed v at the sampling point. In this case, the head movement speed computation unit 202b is not necessary.

The constant speed controller 202 repeats constant speed control (block 406) in preset sampling cycles. Namely, the constant speed controller 202 performs constant speed control, in which the VCM current determined from the back electromotive force of the VCM 15 (more specifically, the head movement speed v corresponding to the back electromotive force) is supplied to the VCM 15 whenever the back EMF detector 163 detects the back electromotive force in each sampling cycle. The thus-determined VCM current is necessary to unload the head 12 onto the ramp 15 at the target speed TVe (TVe>TVn).

As described above, in the embodiment, constant speed control is performed to unload the head 12 onto the ramp 17. The constant speed control enables the head 12 to be unloaded relatively safely at high speed, although the impact occurring when the actuator 14 is latched by the stopper becomes greater than in the case of normal head unload control. Further, in the embodiment, constant speed control is performed, based on the back electromotive force of the VCM 15 that is generated when the constant speed controller 202 drives the VCM 15. Accordingly, the head 12 can be unloaded without being influenced by variations in the rotational speed of the head 12 due to fall of the electronic device 1.

Note that the higher the set target speed TVe, the higher the unloading speed of the head 12, but the greater the damage of the head 12. In view of this, it is advisable to set the target speed TVe so that the time T required to unload the head 12 will be “Td-ΔT” that is shorter by an error ΔT than the time Td.

The zero-speed detector 203 determines whether the head movement speed v computed by the head movement speed computation unit 202b (i.e., the head movement speed v corresponding to the back electromotive force sampled by the sampling unit 202a) is zero (block 407). If the head movement speed v is not zero (block 407), the counter 204 clears its value CNT (block 408). In contrast, if the head movement speed v is zero (block 407), the counter 204 increments its value CNT by one (block 409). The count value CNT indicates the number of times (number of times of sampling) the head movement speed v is successively detected to be 0.

The unload completion determination unit 206 determines whether the one-incremented count value CNT of the counter 204 exceeds a preset reference number Nr of times of sampling (block 410). Namely, the unload completion determination unit 206 determines whether the head movement speed v is successively detected to be 0 over a number of times greater than the reference number Nr.

In general, when the head 12 is unloaded onto the ramp 17 at a certain moving speed, the actuator 14 is latched by the stopper to stop the head 12. In this case, the VCM 15 is not driven even if the VCM current is supplied thereto, whereby the head 12 is kept stopped. Namely, the electromotive force of the VCM 15 and the movement speed v become 0. Therefore, if the head movement speed v is successively detected to be 0 over a number of times greater than the reference number Nr, the unload completion determination unit 206 determines that the head 12 is reliably unloaded on the ramp 17, and determines that emergency head unloading based on constant speed control has been normally completed.

If the count value CNT of the counter 204 does not exceed the reference number Nr (block 410), the unload completion determination unit 206 determines that the head 12 is not yet unloaded (retracted) onto the ramp 17. In this case, the unload completion determination unit 206 determines whether the timer 205 has finished measurement of the time Tc (block 411). Also when the count value CNT of the counter 204 is cleared (block 408), the unload completion determination unit 206 determines whether the timer 205 has finished measurement of the time Tc (block 411).

If timer 205 has not yet finished measurement of the time Tc (block 411), the unload completion determination unit 206 determines that emergency head unloading based on constant speed control is not yet completed. In this case, the constant speed controller 202 again performs constant speed control (block 406).

In contrast, if the timer 205 has finished measurement of the time Tc (block 411), i.e., if the timeout of the timer 205 occurs before it is determined that the head 12 has been unloaded onto the ramp 17, the unload completion determination unit 206 determines that an abnormality has occurred in emergency head unloading based on constant speed control. In this case, the unload completion determination unit 206 stops the constant speed control by the constant speed controller 202, and activates the open-loop controller 207.

The open-loop controller 207, in turn, unloads the head 12 onto the ramp 17 by open loop control for a preset period (e.g., a period of “Td-Tc”) (block 412). At this time, a maximum VCM current that can be output from the open-loop controller 207 is supplied to the VCM 15 for the preset period “Td-Tc.” This enhances the possibility of unloading the head 12 within the time Td elapsing from the start of the emergency unload control, even when an abnormality has occurred in emergency head unloading based on constant speed control. The period “Td-Tc” is measured by the timer 205. After open loop control by the open-loop controller 207 is performed for a preset period, the emergency unload controller 164 finishes the emergency head unload control, and informs the CPU 21 of this (abnormal completion of emergency head unloading) (block 413).

On the other hand, if the count value CNT of the counter 204 exceeds the reference number Nr (block 410), the unload completion determination unit 206 determines that the head 12 has been reliably unloaded (retracted) onto the ramp 17, and. In this case, the emergency unload controller 164 finishes the emergency head unload control, and informs the CPU 21 of this (normal completion of emergency head unloading) (block 413).

Upon receiving, from the emergency unload controller 164, information indicating that emergency head unload control has finished, the CPU 21 releases the emergency unload mode to stop the output of the effective emergency unload signal 210. After that, the CPU 21 causes the HDC 20 to supply the host 100 with a ready signal indicating that the HDD 10 is in a ready state.

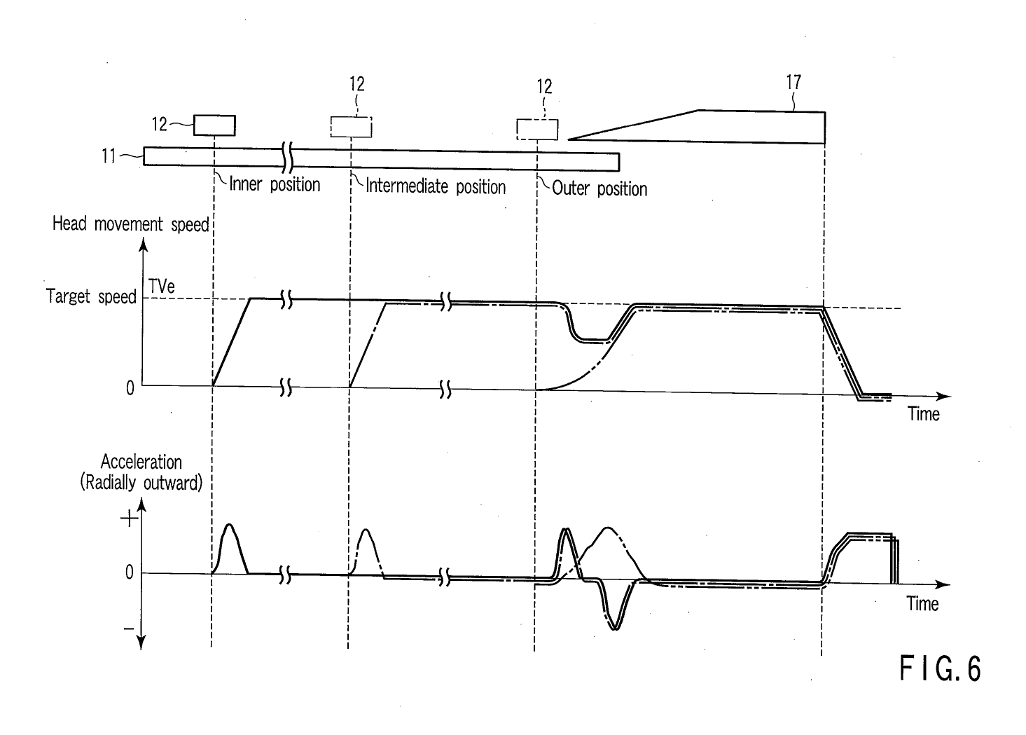

FIG. 6 shows a relationship example between the speed (head movement speed) and accelerated speed of the head 12 and the elapsed time during the above-mentioned constant speed control, assumed in each position of the head 12 on the disk 11 at the start of the control. In FIG. 6, the solid lines, one-dot chain lines and two-dot chain lines indicate the above-mentioned relationships assumed when the head 12 is positioned in the inner, intermediate and outer positions on the disk 11 at the start of the control, respectively. In FIG. 6, the acceleration is proportional to the VCM current supplied to the VCM 15.

[Modification]

In the above-mentioned embodiment, the emergency unload controller 164 performs, during constant speed control, sampling of back electromotive force (blocks 406a), computation of the head movement speed v (block 406b) and determination of the VCM current (block 406c). However, these processes may be performed by the CPU 21. Further, the determination using the timer 205 (block 411) and determination using the counter 204 (block 410) may be performed by the CPU 21. Namely, the emergency unload controller 164 may supply the VCM 15 with the VCM current designated by the CPU 21 in each sampling cycle, to thereby unload the head 12 onto the ramp 17 at the target speed TVe. In this case, the VCM driver 162 may be used instead of the emergency unload controller 164. Further, the CPU 21 may incorporate the emergency unload controller 164.

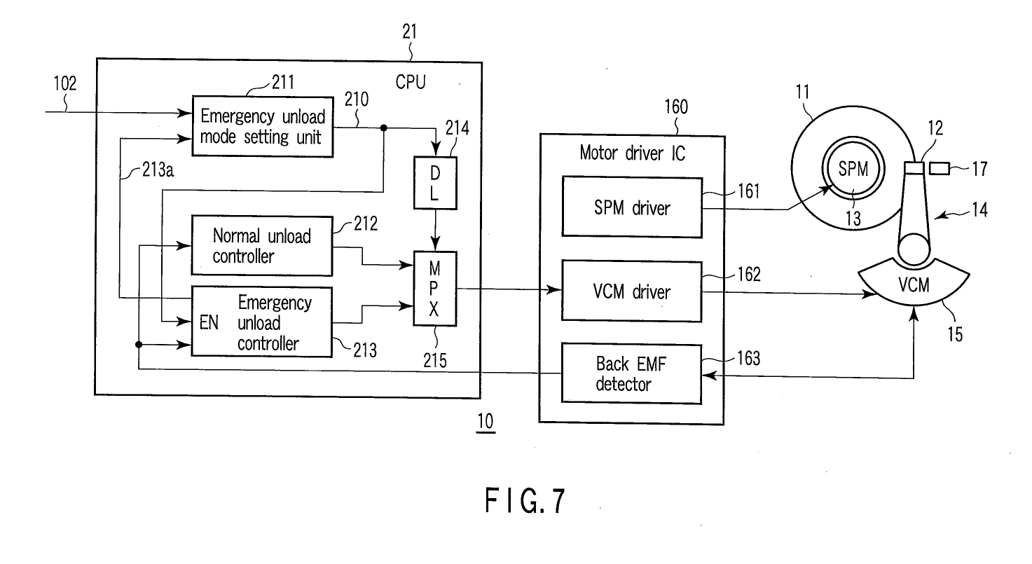

Referring now to FIG. 7, a description will be given of a modification of the above-described embodiment, in which the CPU 21 incorporates a component corresponding to the emergency unload controller 164. FIG. 7 is a block diagram illustrating the essential part of an HDD 10 employed in the modification of the embodiment. In FIGS. 1 and 7, like reference numbers denote like elements. Further, FIG. 7 omits the showing of the head IC 18, read/write IC 19, HDC 20, ROM 22 and RAM 23 shown in FIG. 1.

In the HDD 10 of FIG. 7, a motor driver IC 160 is used instead of the motor driver IC 16 shown in FIG. 1. The former differs from the latter in that the former does not include the emergency unload controller 164.

On the other hand, the CPU 21 in the modification includes an emergency unload mode setting unit 211, normal unload controller 212, emergency unload controller 213, delay unit (DL) 214 and multiplexer (MPX) 215. The emergency unload mode setting unit 211 sets the HDD 10 in an emergency unload mode when the FF detector 101 of the host 100 has output a drop detection signal 102, and outputs an effective emergency unload signal 210.

The normal unload controller 212 becomes operable when the HDD 10 is shifted to the above-mentioned inoperative state. In the operable state, the normal unload controller 212 performs normal unload control for unloading the head 12 onto the ramp 17 at the target speed TVn, as follows:

Firstly, the normal unload controller 212 detects the position of the head 12 until the head 12 reaches the outer periphery of the disk 11, based on a cylinder address contained in servo data periodically read from the disk 11 by the head 12. Whenever the normal unload controller 212 detects the position of the head 12, it determines the VCM current value necessary for the head 12 to reach the target speed (first target speed) TVn. The normal unload controller 212 supplies the multiplexer 215 with information (VCM current information) indicating the determined value (determined VCM current value).

After the head reaches the outer periphery of the disk 11, the normal unload controller 212 periodically samples the back electromotive force detected by the back EMF detector 163. Whenever sampling the back electromotive force, the normal unload controller 212 determines the VCM current value necessary for the movement speed of the head 12 corresponding to the sampled back electromotive force to reach the target speed TVe (TVe>TVn). The normal unload controller 212 supplies the multiplexer 215 with information (VCM current information) indicating the determined value (determined VCM current value).

The emergency unload controller 213 has an enable terminal EN for receiving the emergency unload signal 210 output from the emergency unload mode setting unit 211. The emergency unload controller 213 is operable when an effective emergency unload signal 210 is input to the enable terminal EN, as in the emergency unload controller 164 of the embodiment. When the emergency unload controller 213 is operable, it performs emergency unload control for unloading the head 12 onto the ramp 17 at the target speed TVe, as follows:

Firstly, the emergency unload controller 213 periodically samples the back electromotive force detected by the back EMF detector 163. Whenever sampling the back electromotive force, the emergency unload controller 213 determines the VCM current value necessary for the head 12 to reach the target speed TVe at the target speed TVe (TVe>TVn). The emergency unload controller 213 supplies the multiplexer 215 with information (VCM current information) indicating the determined value (determined VCM current value). Thus, the emergency unload controller 213 differs from the emergency unload controller 164 of the embodiment in that the former outputs VCM current information indicating the determined value (determined VCM current value), instead of outputting a VCM current of the determined value.

The delay circuit 214 delays the emergency unload signal 210, output from the emergency unload mode setting unit 211, by the time required for the emergency unload controller 213 to perform one operation. The multiplexer (MPX) 215 selects one of the VCM current information items output from the emergency unload controller 213 and normal unload controller 212, depending upon whether the emergency unload signal 210 delayed by the delay unit 214 is effective. More specifically, when the delayed emergency unload signal 210 is effective, the multiplexer 215 selects the VCM current information output from the emergency unload controller 213. In contrast, when the delayed emergency unload signal 210 is ineffective, the multiplexer 215 selects the VCM current information output from the normal unload controller 212.

As a result, when the emergency unload controller 213 operates, the VCM current information output therefrom in each sampling cycle is selected by the multiplexer 215. The selected VCM current information is supplied, as the VCM current information from the CPU 21, to the VCM driver 162 of the motor driver IC 160. The VCM driver 162 supplies the VCM 15 with a VCM current of the value indicated by the VCM current information, thereby driving the VCM 15 and moving the head 12.

The conditions for completing the emergency unload control performed by the emergency unload controller 213 are identical to those employed in the emergency unload controller 164 of the embodiment. When finishing the emergency unload control, the emergency unload controller 213 informs the emergency unload mode setting unit 211 of it, by sending an emergency unload finish signal 213a thereto. Upon receiving the signal 213a, the emergency unload mode setting unit 211 releases the emergency unload mode to stop the output of the effective emergency unload signal 210.

The functions of the above-mentioned emergency unload mode setting unit 211, normal unload controller 212, emergency unload controller 213, delay unit 214 and multiplexer (MPX) 215 can also be realized by the CPU's execution of a control program stored in the ROM 22.

While certain embodiments of the inventions have been described, these embodiments have been presented by way of example only, and are not intended to limit the scope of the inventions. Indeed, the novel apparatuses and methods described herein may be embodied in a variety of other forms; furthermore, various omissions, substitutions and changes in the form of the apparatuses and methods described herein may be made without departing from spirit of the inventions. The accompanying claims and their equivalents are intended to cover such forms or modifications as would fall within the scope and spirit of the inventions.

What is claimed is:

1. A disk drive for use in a portable electronic device including a fall detector for detecting fall of the portable electronic device, comprising:
a head used to write and read data to and from a disk;
a ramp onto which the head is unloaded;
an actuator which supports the head such that the head is radially movable over the disk, the actuator including a voice coil motor as a driving source for the actuator; and
a constant speed controller configured to unload the head onto the ramp at a constant speed in accordance with a fall detection signal output from the fall detector and indicating that fall of the portable electronic device has been detected, the constant speed controller performing constant speed control for driving the voice coil motor to make a movement speed of the head identical to a first target speed, the first target speed being set higher than a second target speed set when the head is unloaded onto the ramp in a normal state.

2. The disk drive of claim 1, further comprising a back electromotive force detector configured to detect a back electromotive force of the voice coil motor generated when the voice coil motor is driven, and wherein the constant speed controller performs the constant speed control to make the movement speed of the head identical to the first target speed, while sampling the back electromotive force detected by the back electromotive force detector, the movement speed of the head corresponding to the sampled back electromotive force.

3. The disk drive of claim 2, wherein the constant speed controller includes:
a sampling unit configured to sample the back electromotive force detected by the back electromotive force detector; and
a feedback controller configured to perform feedback control for making the movement speed of the head identical to the first target speed based on an error of the movement speed of the head corresponding to the sampled back electromotive force with respect to the first target speed, the feedback controller determining a value of current that is necessary to make the movement speed of the head identical to the first target speed and is to be supplied to the voice coil motor, the feedback controller supplying the determined value of current to the voice coil motor.

4. The disk drive of claim 2, wherein the first target speed is required for the head to be unloaded from a radially inner position on the disk onto the ramp within a first time period, the first time period being shorter than a second time period required for the portable electronic device to fall by a preset distance.

5. The disk drive of claim 4, further comprising:
a timer which measures the first time period elapsing from a start of the constant speed control;
a counter configured to count a number of times the movement speed of the head corresponding to the sampled back electromotive force is successively detected to be zero; and
an unload completion determination unit configured to determine that unloading of the head has been completed normally, when the counted number of times exceeds a reference number of times before the timer has measured the first time period.

6. The disk drive of claim 5, further comprising an open-loop controller configured to unload the head onto the ramp using open loop control when the timer has counted the first time period before the counted number of times exceeds the reference number of times, the open-loop controller executing the open loop control by supplying the voice coil motor with a maximum current that is allowed to be supplied to the voice coil motor.

7. The disk drive of claim 6, wherein the open-loop controller executes the open loop control for a third time period corresponding to a difference between the first and second time periods.

8. The disk drive of claim 6, wherein the unload completion determination unit determines that unloading of the head by the constant speed controller has been completed abnormally to activate the open-loop controller, when the timer has measured the first time period before the counted number of times exceeds the reference number of times.

9. A portable electronic device comprising:
a disk drive; and
a host which uses the disk drive as a storage device,
wherein
the host includes a fall detector which detects fall of the portable electronic device, and informs the disk drive of the fall using a fall detection signal, and
the disk drive includes:
a head used to write and read data to and from a disk;
a ramp onto which the head is unloaded;
an actuator which supports the head such that the head is radially movable over the disk, the actuator including a voice coil motor as a driving source for the actuator; and
a constant speed controller configured to unload the head onto the ramp at a constant speed in accordance with a fall detection signal output from the fall detector and indicating that fall of the portable electronic device has been detected, the constant speed controller performing constant speed control for driving the voice coil motor to make a movement speed of the head identical to a first target speed, the first target speed being set higher than a second target speed set when the head is unloaded onto the ramp in a normal state.

10. The portable electronic device of claim 9, wherein the disk drive further includes a back electromotive force detector configured to detect a back electromotive force of the voice coil motor generated when the voice coil motor is driven, and wherein the constant speed controller performs the constant speed control to make the movement speed of the head identical to the first target speed, while sampling the back electromotive force detected by the back electromotive force detector, the movement speed of the head corresponding to the sampled back electromotive force.

11. The portable electronic device of claim 10, wherein the constant speed controller includes:
a sampling unit configured to sample the back electromotive force detected by the back electromotive force detector; and
a feedback controller configured to perform feedback control for making the movement speed of the head identical to the first target speed based on an error, with respect to the first target speed, of the movement speed of the head corresponding to the sampled back electromotive force, the feedback controller determining a value of current that is necessary to make the movement speed of the head identical to the first target speed and is to be supplied to the voice coil motor, the feedback controller supplying the determined value of current to the voice coil motor.

12. A method of unloading a head onto a preset retract area when a portable electronic device provided with a disk drive including the head falls, the head being used to write and read data to and from a disk and supported by an actuator such that the head is radially movable over the disk, the actuator including a voice coil motor as a driving source for the actuator, the method comprising:
periodically sampling a movement speed of the head when fall of the portable electronic device has been detected by a fall detector incorporated in the portable electronic device;
executing constant speed control for driving the voice coil motor to make the movement speed of the head identical to a first target speed whenever the movement speed of the head is sampled, the first target speed being set higher than a second target speed set when the head is unloaded onto the ramp in a normal state.

13. The method of claim 12, wherein the movement speed of the head is sampled by sampling a back electromotive force of the voice coil motor, the movement speed of the head corresponding to the sampled back electromotive force of the voice coil motor, the back electromotive force of the voice coil motor being generated when the voice coil motor is driven.

14. The method of claim 13, wherein the sampling the movement speed of the head includes:
sampling the back electromotive force of the voice coil motor; and
computing a movement speed of the head corresponding to the sampled back electromotive force.

15. The method of claim 12, wherein the executing the constant speed control includes:
determining a value of current to be supplied to the voice coil motor and necessary to make the movement speed of the head identical to the first target speed, based on an error, with respect to the first target speed, of the sampled movement speed of the head; and
supplying the voice coil motor with the determined value of current.

16. The method of claim 12, wherein the first target speed is required for the head to be unloaded from a radially inner position on the disk onto the ramp within a first time period, the first time period being shorter than a second time period required for the portable electronic device to fall by a preset distance.

17. The method of claim 16, further comprising:
measuring the first time period elapsing from a start of the constant speed control;
determining whether the movement speed of the head is zero, whenever the constant speed control is executed;
incrementing, by one, a count value of a counter whenever it is determined that the movement speed of the head is zero,
initializing the count value of the counter to be zero when it is determined that the movement speed of the head is not zero; and
determining that unloading of the head has been completed normally, when the count value exceeds a reference value within the first time period.

18. The method of claim 17, further comprising unloading the head onto the ramp using open loop control, when measurement of the first time period has been finished before the count value exceeds the reference value.
